(19) United States
(12) Patent Application Publication
(10) Pub. No.: US 2009/0322624 A1
(43) Pub. Date: Dec. 31, 2009

(54) FILM TYPE ANTENNA AND MOBILE COMMUNICATION TERMINAL HAVING THE SAME

(75) Inventors: Ha Ryong HONG, Hwaseong (KR); Jae Suk Sung, Yongin (KR); Kyong Keun Lee, Suwon (KR); Chan Gwang An, Suwon (KR); Hyun Kil Nam, Seoul (KR); Dae Seong Jeon, Suwon (KR); Sung Eun Cho, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., SUWON (KR)

(21) Appl. No.: 12/270,263

(22) Filed: Nov. 13, 2008

(30) Foreign Application Priority Data
Jun. 30, 2008 (KR) 10-2008-0063129

(51) Int. Cl. H01Q 1/38; H01Q 1/24

(52) U.S. Cl. 343/702; 343/700 MS

(57) ABSTRACT

There are provided a film type antenna and a mobile communication terminal having the same. A film type antenna according to an aspect of the invention may include: a first carrier film having a conductive pattern on at least one surface thereof; an adhesion strengthening layer provided on the first carrier film; and a second carrier film laminated on the adhesion strengthening layer.

### CROSS-REFERENCE TO RELATED APPLICATIONS

This application claims the priority of Korean Patent Application No. 2008-0063129 filed on Jun. 30, 2008, in the Korean Intellectual Property Office, the disclosure of which is incorporated herein by reference.

### BACKGROUND OF THE INVENTION

1. Field of the Invention

The present invention relates to film type antennas and mobile communication terminals having the same, and more particularly, to a film type antenna having a decoration carrier film that provides strengthened adhesion between a decoration carrier film and a carrier film on which a radiator is formed, and a mobile communication having the same.

2. Description of the Related Art

Recently, mobile communication terminals, such as GPS, PDAs, cellular phones, and wireless notebook computers, have come into widespread use. A reduction in size, thickness, and weight has been increasingly required for the mobile communication terminals. To meet these needs, emphasis is placed upon reducing the size of the mobile communication terminals, while the mobile communication terminals maintain various functions. Particular attention is also placed upon antennas, which are one of the most important components of mobile communication terminals.

In general, among antennas of mobile communication terminals, an external antenna, such as a rod antenna or a helical antenna, protrudes from the outside of a mobile communication terminal by a predetermined distance. This increases the size and reduces the portability of the terminal. Furthermore, if the terminal is dropped, the external antenna is susceptible to damage.

On the contrary, an internal antenna that is mounted onto the inside of the mobile communication terminal, such as a surface mounted chip antenna, may be less damaged. However, the physical size of the internal antenna makes it difficult to reduce the size of the mobile communication terminal.

Therefore, research has been conducted on antennas of mobile communication terminals that reduce size and enhance stability.

### SUMMARY OF THE INVENTION

An aspect of the present invention provides a film type antenna that can form a radiator pattern and a decoration layer integrally with a housing of a mobile communication terminal by using a carrier film, and a mobile communication terminal using the same.

According to an aspect of the present invention, there is provided a film type antenna including: a first carrier film having a conductive pattern on at least one surface thereof; an adhesion strengthening layer provided on the first carrier film; and a second carrier film laminated on the adhesion strengthening layer.

The adhesion strengthening layer may include heat resistant ink.

The adhesion strengthening layer may include: a first printing layer in contact with the first carrier film; a second printing layer in contact with the second carrier film; and an adhesive tape provided between the first printing layer and the second printing layer.

Each of the first printing layer and the second printing layer may include heat resistant ink.

The second carrier film may be a decoration carrier film.

The film type antenna may further include a decoration printing layer provided on one surface of the second carrier film.

The decoration printing layer may be provided between the second carrier film and the adhesion strengthening layer.

According to another aspect of the present invention, there is provided a mobile communication terminal including: a film type antenna including a first carrier film having a conductive pattern on at least one surface thereof, an adhesion strengthening layer provided on the first carrier film, and a second carrier film laminated on the adhesion strengthening layer; and a housing in contact with the first carrier film.

The film type antenna may be formed integrally with the housing by in-molding labeling.

The housing may be in contact with one surface of the first carrier film facing the other surface thereof on which the adhesion strengthening layer is laminated.

The adhesion strengthening layer may include heat resistant ink.

The adhesion strengthening layer may include: a first printing layer in contact with the first carrier film; a second printing layer in contact with the second carrier film; and an adhesive tape provided between the first printing layer and the second printing layer.

Each of the first printing layer and the second printing layer may include heat resistant ink.

The second carrier film may be a decoration carrier film.

The mobile communication terminal may further include a decoration printing layer provided on one surface of the second carrier film.

The decoration printing layer may be provided between the second carrier film and the adhesion strengthening layer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a film type antenna according to an exemplary embodiment of the invention;

FIG. 2 is a cross-sectional view illustrating a film type antenna according to another exemplary embodiment of the invention;

FIG. 3 is a cross-sectional view illustrating a mobile communication terminal according to still another exemplary embodiment of the invention; and

FIGS. 4A to 4D are cross-sectional view illustrating a process of manufacturing a mobile communication terminal according to yet another exemplary embodiment of the invention.

### DETAILED DESCRIPTION OF THE PREFERRED EMBODIMENT

Exemplary embodiments of the present invention will now be described in detail with reference to the accompanying drawings.

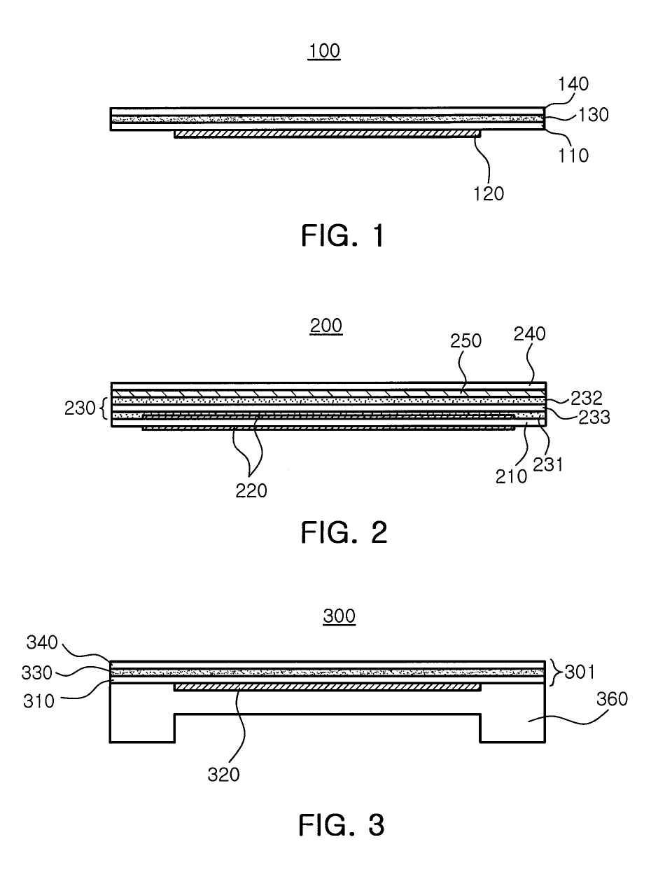

FIG. 1 is a cross-sectional view illustrating a film type antenna according to an exemplary embodiment of the present invention.

Referring to FIG. 1, a film type antenna 100 according to this embodiment may include a first carrier film 110, a conductive pattern 120, an adhesion strengthening layer 130, and a second carrier film 140.

The first carrier film 110 may be formed of a thin insulating material. The first carrier film 110 may be formed of a material that is appropriate to perform in-molding labeling (IML).

Specifically, to manufacture a mobile communication terminal having the film type antenna, the film type antenna 100 is inserted into a mold, synthetic resins used to form a housing of the mobile communication terminal are injected into the mold, and the housing is molded from the synthetic resins at an appropriate temperature and pressure. Therefore, the material used to form the carrier film 110 needs to be a material that does not undergo significant deformation under the pressure and temperature during the in-molding labeling, and at the same time, can be formed integrally with the housing of the mobile communication terminal. In this embodiment, a polymer film may be used as the first carrier film 110. In this embodiment, a polymer film may be used as the first carrier film 110.

The conductive pattern 120 may be formed on one surface of the first carrier film 110. The conductive pattern 120 may serve as a radiator of the film type antenna 100. The conductive pattern 120 may be formed by attaching a previously formed conductive pattern to the first carrier film 110. Alternatively, the conductive pattern 120 may be formed by a printing method using conductive paste or a sputtering method. Though not shown in detail in the drawing, the conductive pattern 120 includes a ground terminal and a power feeding terminal connected to the outside. The conductive pattern 120 may have various shapes.

In this embodiment, a conductive pattern is formed on one surface of the first carrier film. However, conductive patterns may be formed on both surfaces of the first carrier film.

The second carrier film 140 may be a decoration carrier film.

When the conductive pattern 120 is formed on the first carrier film 110, and the first carrier film 110 is formed integrally with the housing by the in-molding process, the conductive pattern and the carrier film may be exposed on an outer surface of the housing. In this case, the exposure of the conductive pattern to the outside spoils the appearance of the housing, and there is a concern regarding piracy of the pattern of the radiator. Therefore, in this embodiment, a decoration carrier film may be used as the second carrier film 140. Here, the coloring of the second carrier film 140 can prevent the observation of the shape of the conductive pattern with the naked eye.

Further, a decoration layer (not shown) may be additionally formed on the second carrier film. Though significant decorative effects of the surface of the housing are not caused by the second carrier film, a separate decoration layer is formed so that various kinds of patterns can be formed on the outer surface of the housing of the mobile communication terminal onto which the film type antenna is mounted.

The adhesion strengthening layer 130 may be formed between the first carrier film 110 and the second carrier film 140.

In order to apply the second carrier film 140 over the first carrier film 110, an adhesive material may be needed. The adhesion strengthening layer 130 may serve as an adhesive material. In this embodiment, the adhesion strengthening layer may include heat resistant ink.

According to in-molding labeling, a film type antenna having a plurality of carrier films laminated thereon may be formed integrally with the housing of the mobile communication terminal at high temperature. Therefore, during the in-molding labeling, the plurality of carrier films may be separated from each other due to poor adhesion therebetween. This may spoil the appearance of the second carrier film 140 that is exposed on the outer surface of the housing.

In this embodiment, since heat resistant ink that can maintain adhesion at high temperature is used between the first carrier film 110 and the second carrier film 140, good adhesion between the first carrier film 110 and the second carrier film 140 can be provided during the in-molding labeling.

FIG. 2 is a cross-sectional view illustrating a film type antenna according to another embodiment of the invention.

Referring to FIG. 2, a film type antenna 200 according to this embodiment may include a first carrier film 210, conductive patterns 220, an adhesion strengthening layer 230, a second carrier film 240, and a decoration layer 250.

The first carrier film 210 may be formed of a thin insulating material. The first carrier film 210 may be formed of a material that is appropriate to perform in-molding labeling (IML).

Specifically, to manufacture a mobile communication terminal having the film type antenna, the film type antenna 200 is inserted into a mold, synthetic resins used to form a housing of the mobile communication terminal are injected into the mold, and the housing is molded from the synthetic resins at an appropriate temperature and pressure. Therefore, the material used to form the carrier film 210 needs to be a material that does not undergo significant deformation under the pressure and temperature during the in-molding labeling, and at the same time, can be formed integrally with the housing of the mobile communication terminal. In this embodiment, a polymer film may be used as the first carrier film 210.

The conductive patterns 220 may be formed on both sides of the first carrier film 210. The conductive patterns 220 may serve as a radiator of the film type antenna 200. Unlike the embodiment, shown in FIG. 1, the conductive patterns 220 that are symmetrical with each other may be formed on both sides of the first carrier film 210 in this embodiment.

The conductive patterns 220 may have the same shape and size, and face each other. Further, power feeding terminals of the conductive patterns may be separated from each other so that the power feeding terminals can be connected to different polarities. Accordingly, an antenna having a balanced structure can be realized.

In a film type antenna having a radiator with a balanced structure, each of the conductive patterns 220 may have a current characteristic with a balanced structure. That is, since the conductive patterns 220 generate outputs having the same magnitude but a phase difference of 180° therebetween, the influence caused by noise and environmental changes can be reduced. Therefore, when compared to a film type antenna according to the related art, higher reliabilities can be expected.

Further, a film type antenna having a radiator with a balanced structure according to the embodiment of the invention can perform a balanced connection with various kinds of passive elements, such as switches, duplexers, and filters, and/or active elements, such as amplifiers having balanced input structures, without using separate circuits, thereby simplifying an external circuit.

The conductive patterns 220 may be formed by attaching a previously formed conductive pattern to the first carrier film 210. Alternatively, the conductive patterns 220 may be formed by a printing method using conductive paste or a sputtering method. Further, though not shown in detail in the drawing, the conductive patterns 220 may include and a ground terminal and a power feeding terminal that can be connected to the outside, and have various kinds of shapes.

The second carrier film 240 may be a decoration carrier film. That is, the decoration printing layer 250 may be formed on the second carrier film 240. The second carrier film 240 may be formed of a transparent material, and various kinds of patterns may be formed on the decoration printing layer 250.

When the first carrier film 210 is formed on the conductive patterns 220, and the first carrier film is formed integrally with the housing by in-molding labeling, the conductive pattern and the first carrier film may be exposed on the outer surface of the housing. Here, the exposure of the conductive pattern may spoil the appearance of the housing, and there is concern regarding piracy of the pattern of the radiator.

In this embodiment, by forming the separate decoration printing layer 250 on the second carrier film 240, various kinds of patterns may formed on the outer surface of the housing of the mobile communication terminal onto which the film type antenna is mounted.

The adhesion strengthening layer 230 may be formed between the first carrier film 210 and the second carrier film 240. In this embodiment, the adhesion strengthening layer 230 may be formed between the first carrier film 210 and the decoration printing layer 250.

In this embodiment, the adhesion strengthening layer 230 may include a first printing layer 231, a second printing layer 232, and an adhesive tape 233.

The first printing layer 231 may be in contact with the first carrier film 210. The first printing layer may include heat resistant ink. The first printing layer may be printed onto the first carrier film.

The second printing layer 232 may be in contact with the second carrier film 240. In this embodiment, a second printing layer may be printed onto the second carrier film 240 so as to cover the decoration printing layer 250. The second printing layer 232 may include heat resistant ink.

The adhesive tape 233 may be formed between the first printing layer 231 and the second printing layer 232.

During the manufacturing process, the first printing layer 231 is formed on the first carrier film 210 so as to cover the conductive pattern 220, the second printing layer 232 is formed on the second carrier film 240 so as to cover the decoration printing layer 250, and the first printing layer 231 and the second printing layer 232 are attached to each other by using the adhesive tape 233.

In order that the second carrier film 240 having the decoration printing layer 250 formed thereon is laminated onto the first carrier film 210 having the conductive patterns 220 formed thereon, an adhesive material may be needed. The first printing layer 231 and the second printing layer 232 that are formed between the first carrier film 210 and the second carrier film 240 may serve as adhesive materials. In this embodiment, each of the first printing layer 231 and the second printing layer 232 may include heat resistant ink.

According to in-molding labeling, the film type antenna having the first carrier film 210 and the second carrier film 240 laminated thereon is integrally formed with the housing of the mobile communication terminal at high temperature. Therefore, during the in-molding labeling, the plurality of carrier films may be separated from each other due to poor adhesion therebetween. This may spoil the appearance of the second carrier film 240 that is exposed on the outer surface of the housing.

In this embodiment, since heat resistant ink that can maintain adhesion at high temperature is used between the first carrier film 210 and the second carrier film 240, good adhesion can be maintained between the first carrier film 210 and the second carrier film 240 during the in-molding labeling.

FIG. 3 is a cross-sectional view illustrating a mobile communication terminal according to still another embodiment of the invention.

Referring to FIG. 3, a mobile communication terminal 300 may include a film type antenna 301, and a housing 360 of the mobile communication terminal.

The film type antenna 301 may include a first carrier film 310, a conductive pattern 320, an adhesion strengthening layer 330, and a second carrier film 340.

The first carrier film 310 may be formed of a thin insulating material. The first carrier film 310 may be formed of a material that is appropriate to perform in-molding labeling (IML). In this embodiment, a polymer film may be used as the first carrier film 310.

The conductive pattern 320 may be formed on one surface of the first carrier film 310. The conductive pattern 320 may serve as a radiator of the film type antenna 301. In this embodiment, a conductive pattern is only formed on one surface of the first carrier film. However, conductive patterns may be formed on both surfaces of the first carrier film.

The second carrier film 340 may be a decoration carrier film. The coloring of the second carrier film 340 may prevent the observation of the shape of the conductive pattern with the naked eye. Further, a separate decoration layer (not shown) may be formed on the second carrier film. As a separate decoration printing layer is formed on the second carrier film, various kinds of patterns can be formed on the outer surface of the housing of the mobile communication terminal onto which the film type antenna is formed.

The adhesion strengthening layer 330 may be formed between the first carrier film 310 and the second carrier film 340. The adhesion strengthening layer 330 may serve as an adhesive material. In this embodiment, the adhesive strengthening layer 330 may include heat resistant ink.

In this embodiment, since heat resistant ink that can maintain adhesion at high temperature is used between the first carrier film 310 and the second carrier film 340, good adhesion can be maintained between the first carrier film 310 and the second carrier film 340.

The adhesion strengthening layer 330 may include a first printing layer, a second printing layer, and an adhesive tape as shown in FIG. 2.

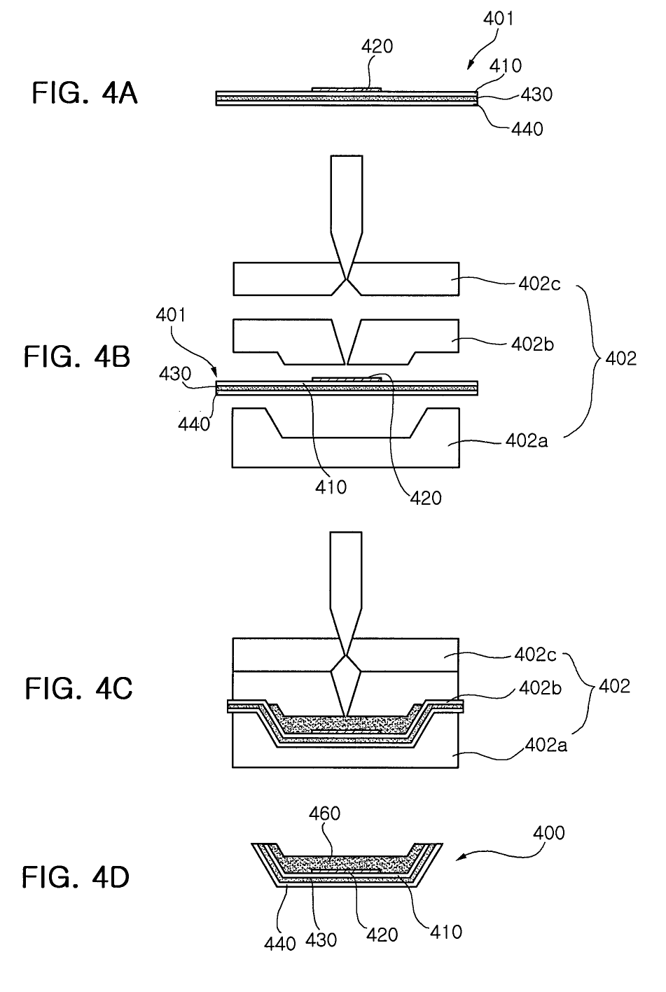

FIGS. 4A to 4D are cross-sectional views illustrating the process flow to manufacture a housing of a mobile communication terminal according to yet another embodiment of the invention.

In a process shown in FIG. 4A, a film type antenna according to this embodiment of the invention is formed. Here, a first carrier film 410 having a conductive pattern 420 formed on one surface thereof, and a decoration second carrier film 440 are laminated to form the film type antenna. An adhesion strengthening layer 430 that includes heat resistant ink may be formed between the first carrier film 410 and the second carrier film 440.

In a process shown in FIG. 4B, a film type antenna 401 having a lamination is disposed inside a mold 402 used to form a housing of a mobile communication terminal. The mold 402 may include a first portion 402a, a second portion 402b, and a third portion 402c. The first portion 402a is in contact with the second carrier film 440, and forms a bottom surface of the mold. The second portion 402b forms a top surface of the mold, and a molding material is injected into the second portion 402b. The third portion 402c is connected to the storage of the molding material through a nozzle. The film type antenna 401 is inserted between the first portion 402a and the second portion 402b of the mold. The conductive pattern 420 of the antenna that is formed on the first carrier film may be disposed and directly contact the molding material during the molding process.

In a process shown in FIG. 4C, the housing of the mobile communication terminal is integrally formed with the film type antenna within the mold. During this process, all of the portions of the mold 402 are assembled with each other, and the molding material may be injected into the mold 402 through the nozzle under constant pressure. Here, the pressure causes deformation of the film type antenna 401 into the first portion 402a of the mold 402. The molding material injected into the mold fills in a space between the second portion 402b and the first portion 402a of the mold 402. The molding process may be performed by previously deforming the film type antenna to have a predetermined shape before inserting the film type antenna into the mold.

FIG. 4D is a view illustrating a mobile communication terminal 400 that is formed integrally with the film type antenna by performing cooling and hardening processes after compressing the mold 402.

In the mobile communication terminal 400 according to this embodiment, the conductive pattern 420 forming a radiator of the antenna is integrally formed with a housing 460 of the mobile communication terminal, thereby reducing the area where the antenna is mounted. Therefore, the mobile communication terminal 400 can be reduced in size. Further, the decoration second carrier film 440 that is exposed on the outer surface of the housing 460 of the mobile communication terminal is used to decorate the outer surface.

As set forth above, according to the exemplary embodiments of the invention, a film type antenna having a radiator pattern formed on a carrier film can provide good adhesion between carrier films, and a mobile communication terminal having the film type antenna is provided.

While the present invention has been shown and described in connection with the exemplary embodiments, it will be apparent to those skilled in the art that modifications and variations can be made without departing from the spirit and scope of the invention as defined by the appended claims.

What is claimed is:

1. A film type antenna comprising:
a first carrier film having a conductive pattern on at least one surface thereof;
an adhesion strengthening layer provided on the first carrier film; and
a second carrier film laminated on the adhesion strengthening layer.

2. The film type antenna of claim 1, wherein the adhesion strengthening layer comprises heat resistant ink.

3. The film type antenna of claim 1, wherein the adhesion strengthening layer comprises:
a first printing layer in contact with the first carrier film;
a second printing layer in contact with the second carrier film; and
an adhesive tape provided between the first printing layer and the second printing layer.

4. The film type antenna of claim 3, wherein each of the first printing layer and the second printing layer comprises heat resistant ink.

5. The film type antenna of claim 1, wherein the second carrier film is a decoration carrier film.

6. The film type antenna of claim 1, further comprising a decoration printing layer provided on one surface of the second carrier film.

7. The film type antenna of claim 6, wherein the decoration printing layer is provided between the second carrier film and the adhesion strengthening layer.

8. A mobile communication terminal comprising:
a film type antenna including a first carrier film having a conductive pattern on at least one surface thereof, an adhesion strengthening layer provided on the first carrier film, and a second carrier film laminated on the adhesion strengthening layer; and
a housing in contact with the first carrier film.

9. The mobile communication terminal of claim 8, wherein the film type antenna is formed integrally with the housing by in-molding labeling.

10. The mobile communication terminal of claim 8, wherein the housing is in contact with one surface of the first carrier film facing the other surface thereof on which the adhesion strengthening layer is laminated.

11. The mobile communication terminal of claim 8, wherein the adhesion strengthening layer comprises heat resistant ink.

12. The mobile communication terminal of claim 8, wherein the adhesion strengthening layer comprises:
a first printing layer in contact with the first carrier film;
a second printing layer in contact with the second carrier film; and
an adhesive tape provided between the first printing layer and the second printing layer.

13. The mobile communication terminal of claim 12, wherein each of the first printing layer and the second printing layer comprises heat resistant ink.

14. The mobile communication terminal of claim 8, wherein the second carrier film is a decoration carrier film.

15. The mobile communication terminal of claim 8, further comprising a decoration printing layer provided on one surface of the second carrier film.

16. The mobile communication terminal of claim 15, wherein the decoration printing layer is provided between the second carrier film and the adhesion strengthening layer.
